(19) United States
(12) Patent Application Publication
(10) Pub. No.: US 2024/0034132 A1
(43) Pub. Date: Feb. 1, 2024

(54) COLLAPSIBLE VEHICLE DOOR

(71) Applicants: James Clancy, Thompson's Station, TN (US); John Vrba, Geneva, IL (US)

(72) Inventors: James Clancy, Thompson's Station, TN (US); John Vrba, Geneva, IL (US)

(73) Assignees: 622 innovations LLC, Thompson's Station, TN (US); 622 Innovations LLC, Thompson's Station, TN (US)

(21) Appl. No.: 18/240,321

(22) Filed: Aug. 30, 2023

Related U.S. Application Data
(63) Continuation-in-part of application No. 17/396,897, filed on Aug. 9, 2021, now abandoned.

(51) Int. Cl. B60J 5/04

(52) U.S. Cl. CPC B60J 5/0487; B60J 5/047; B60J 5/048

(57) ABSTRACT

A flexible, collapsible vehicle door is provided that can be easily installed and uninstalled on a vehicle, without modification to the vehicle. The uninstalled door can be rolled up into a compact configuration allowing for storage. The collapsible door includes latches which secure the door to the top and bottom of the door frame. Straps on top and bottom of the door further hold the frame in place. The flexible door material rolls down from the top of the frame when needed for use. The door further attaches to the frame by way of two steel posts that fit the inside hinge openings on the stock vehicle body. A latch portion of the collapsible door may be used to secure the collapsible door in the closed position.

### CROSS-REFERENCE TO RELATED APPLICATIONS

This application is a Continuation in part of patent application Ser. No. 17/396,897, filed Aug. 9, 2021.

### BACKGROUND OF THE INVENTION

### Technical Field

The present invention relates to a flexible, collapsible vehicle door that can be easily installed and uninstalled on a vehicle, without modification to the vehicle. More particularly, the invention provides a door that can be rolled up into a compact configuration when not in use.

### Description of the Prior Art

Vehicle door removal is a common modification made by cabined vehicle operators to provide a more enjoyable riding experience, particularly in sport utility vehicles (SUVs) such as the “Jeep Wrangler” or “Ford Bronco”. This presents a problem, for example, during periods of inclement weather where the vehicle's cabin may become damaged or uncomfortable due to exposure to the elements.

As a solution to this problem, a collapsible vehicle door was proposed by Wilfred Bright in U.S. Pat. No. 2,682,427, (hereinafter Bright) to close the passenger compartment. However, the Bright design required a permanent modification to the vehicle and installation was cumbersome and slow.

U.S. Pat. No. 10,106,019 (hereinafter Rafeld) proposed an improved collapsible door design which includes frame pieces that can be fixed together to form a frame. While this improves the fit of the door by providing rigidity to the installed collapsible door disclosed. This approach requires manipulation of the frame pieces within the door cover in order to snap them into place within the door frame.

Prior art collapsible doors suffer from numerous deficiencies, so that there remains a need for a more improved collapsible door that can provide protection from the elements while being rapidly deployed. The present invention addresses these needs by providing an easily attachable and detachable door frame with a roll-down covering that can be pulled into place in a single step and then stowed into the top of the frame by reversing that step.

### SUMMARY OF THE INVENTION

In order to overcome the deficiencies of the prior art, the collapsible vehicle door of the invention provides a vehicle door that does not require periodic removal for storage. Instead, the collapsible vehicle door of the invention straps and connects to the top of the door frame and rolls down like a window shade when needed. Moreover, the collapsible vehicle door of the invention can be easily installed and uninstalled on a vehicle, without modification to the vehicle. Finally, the collapsible vehicle door of the invention is adaptable for use with door frames of any size and shape, allowing it to be used in place of different doors on the same vehicle or multiple vehicles.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows frame pieces and other portions of a collapsible vehicle door according to some embodiments; and

FIG. 2 shows detail of a collapsible vehicle door in its stored configuration.

FIG. 3 shows an alternative embodiment where the collapsible vehicle door is stored on the top “roll bar” of a vehicle.

FIG. 4 shows the placement of magnets within the material of the CVD for securing the CVD to a vehicle frame.

### DETAILED DESCRIPTION OF THE PREFERRED EMBODIMENT(S)

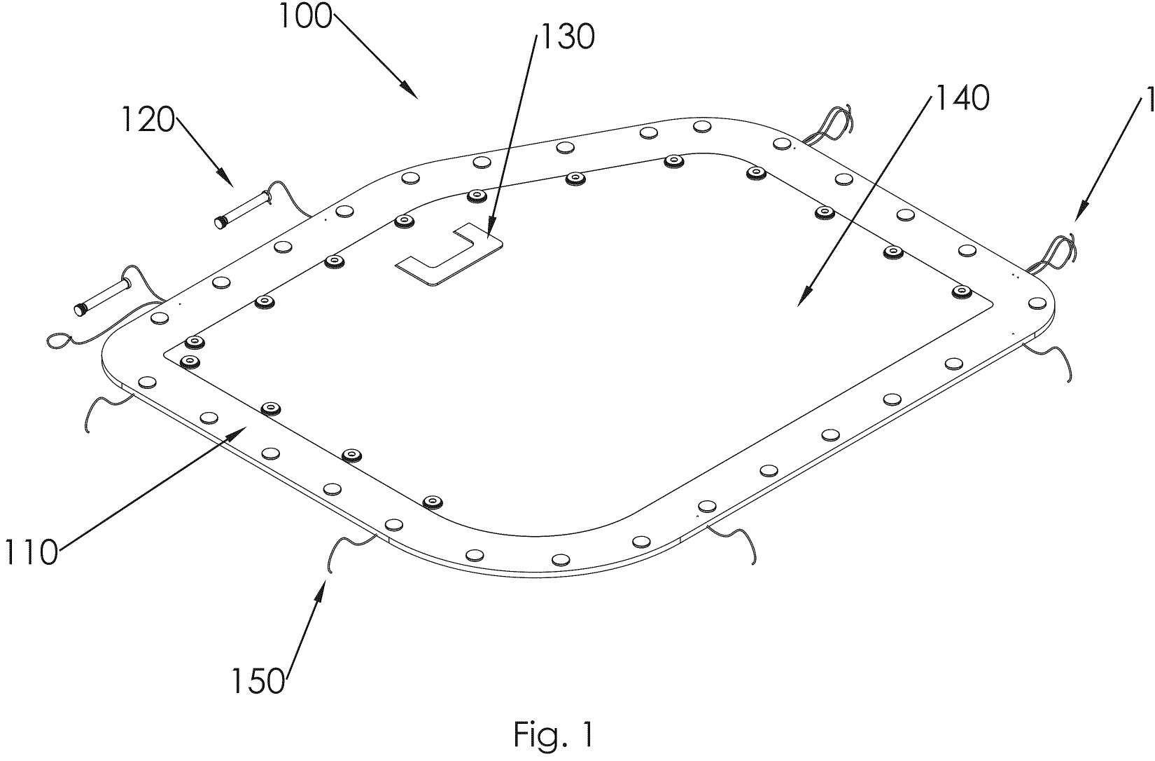

FIG. 1 shows the frame 110 of the collapsible vehicle door (CVD) 100 from an exterior view in accordance with some embodiments. CVD 100 may include one or more hinge portions 120, a latch portion 130 and a cover piece 140. Frame 110 is constructed from flexible frame pieces that can be rolled up to permit CVD 100 to reach its collapsed configuration. The frame 110 may include features such as hooks 150 and straps 160 at its ends to facilitate connecting the frame pieces into the fixed positions. Hooks 150 and straps 160 may be made of any material suitable for securing the frame 110 to the vehicle frame such that the frame 110 does not flex or bend while secured. Such materials may include hook and loop fasteners, flexible plastic materials, hooks, clips and similar pieces.

Hinge portion 120 hingedly connects CVD 100 to hinge portion of the vehicle body and allows CVD 100 to open and close. Advantageously, hinge portion 120 may be configured to operate with the stock hinge portion of a vehicle without modification to the vehicle. Similarly, latch portion 130 may operate with the latch receiver of a vehicle without modification to the vehicle. Cover piece 140 provides a fabric or other material cover over the surface of the frame. In some embodiments a window portion is used to provide visibility to the driver of the vehicle when CVD 100 is in use.

Frame 110 provides the structural support for CVD 100. Frame 110 may be customized both for the particular vehicle type that the door is intended to be used with (e.g., sport utility vehicles such as Jeep Wrangler, Ford Bronco or similar vehicles), and also for the particular door location on the vehicle (e.g., front left, front right, back left, back right). For example, the frame may be configured to follow the contour of the door frame of a vehicle. In an alternative embodiment, CVD 100 only follows a portion of the contour of vehicle door frame to create a “half-door”, which is attached to the bottom of the door frame and then rolled down from the top of the door frame.

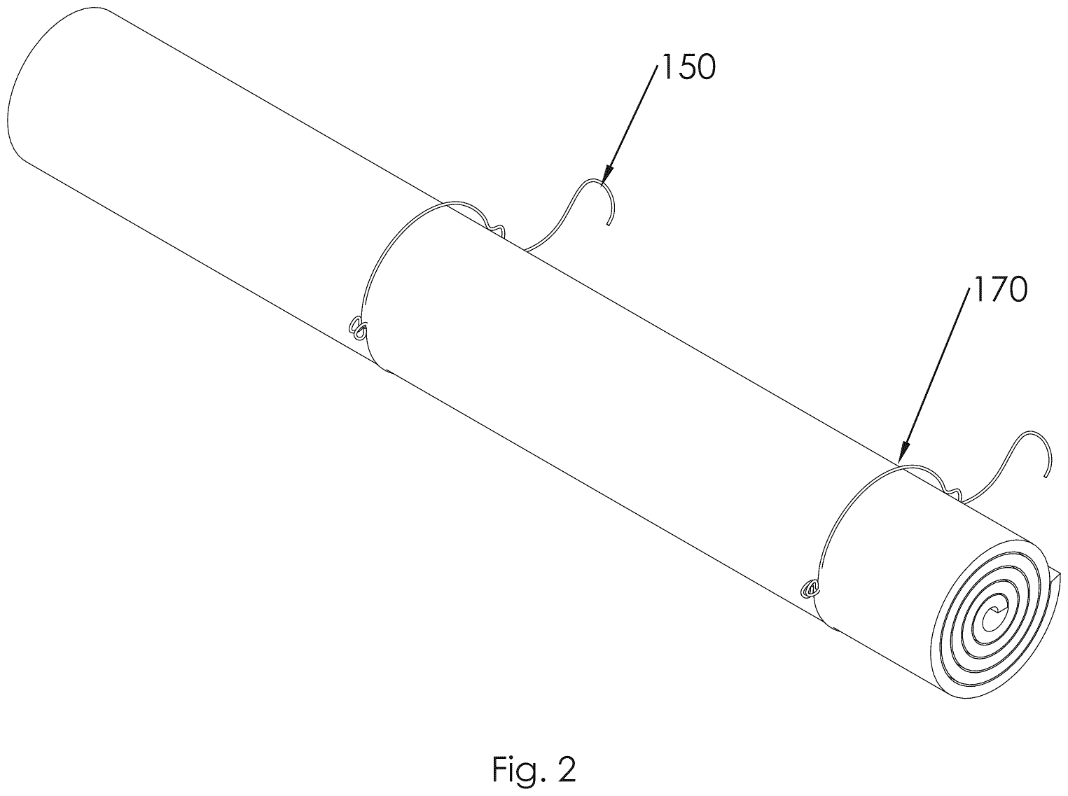

FIG. 2 shows CVD 100 in its stored position attached to either the top or the bottom of the vehicle frame and secured in the closed position by a securing means 170. The securing means 170 may be any suitable way of securing CVD 100 to the vehicle frame, including straps, hooks, magnets or other releasable fasteners.

CVD 100 made be made of any suitable material that is flexible enough to be rolled into a closed position. For example, in some embodiments, a vinyl/polyurethane composition may be used. The contour of vehicle door frame may be determined from specifications provided by the manufacturer or may be measured in any suitable way. Computer control, customized tooling, and other methods may be used to shape raw material into the frame 110. Other suitable materials such as plastics, carbon fiber composites, and the like may be shaped in any suitable way to form frame 110 of CVD 100. Multiple materials may be used in some embodiments. For example, different materials may be used for different frame pieces of frame 110. In some embodiments frame 110 may be shaped at points along its perimeter that follow the contour of the vehicle door frame to provide a close seal. Such a seal may assist in preventing wind, rain, and other exterior conditions from significantly affecting the cabin conditions within the vehicle.

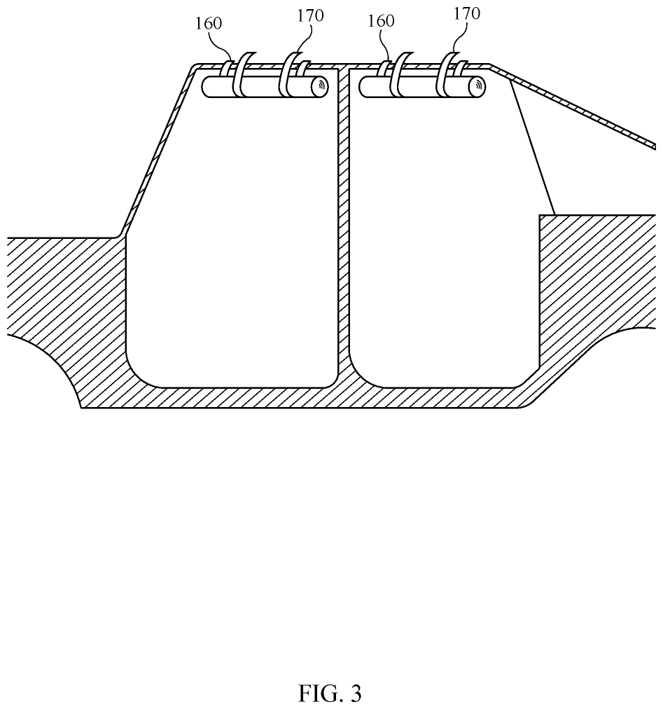

FIG. 3 shows an alternative embodiment where the CVD 100 is stored on the top “roll bar” 190 of a vehicle. When stored in this manner, the CVD 100 is secured to the roll bar by two or more “hook and loop” straps 170 for release and deployment. Additionally, the embodiment includes a single connecting strap 160 that connects the top of the CVD 100 to the roll bar 190. The connecting strap 160 may be further used as a handle for carrying the CVD 100 when the CVD 100 is removed from the roll bar 190 for easy transfer to another vehicle. According to this embodiment of the invention, the front CVD panels roll up to 4.5 inches in diameter. The back CVD panels roll up to 3 inches in diameter. This tight circumference and snug fit to the roll bar 190 does not materially obstruct the vision of the vehicle's occupants when the CVD 100 is stored. Likewise, the CVD 100 does not obstruct ingress and egress from the vehicle in the stored configuration.

Turning back to FIG. 1, in some embodiments the CVD 100 includes hinge portion 120 for hingedly connecting CVD 100 to a vehicle hinge portion. Hinge portion 120 may be adapted in any suitable way for compatibility with the existing hinge portion located on vehicle door frame. Hinge portion 120 may be connected to a suitable location on the frame 110 to ensure CVD 100 will conform with the contour of the vehicle door frame when hinge portion 120 is connected to the vehicle door frame and CVD 100 is in the closed position. Hinge portion 120 of CVD 100 may in fact only be a portion of a hinge as dictated by the model of vehicle to which the collapsible door is to be used.

In one embodiment, hinge portion 120 may comprise hollow cylindrical portion(s) for receiving a pin when aligned with complimentary hollow cylindrical portion(s) of the vehicle hinge portion.

In another embodiment hinge portion 120 may comprise a pin that is inserted into a socket of the hinge portion of the vehicle. Alternatively, hinge portion 120 may comprise a socket which is seated over a pin of the vehicle hinge portion. In yet another embodiment, the hinge portion 120 is a full hinge with a free connection plate for connection to the vehicle door frame.

In some embodiments CVD 100 includes a latch portion 130 for securing CVD in a closed position. Latch portion 130 is connected to the door frame 110 at a location such that when the collapsible door conforms to the vehicle door frame, latch portion 130 is aligned with a corresponding latch portion of the vehicle door frame. Latch portion 130 may be engaged with the latch portion of the vehicle door frame to secure CVD 100 in the closed position. Latch portion 130 may comprise only of that portion of the latch necessary to achieve closure with the latch portion of the vehicle door frame. Latch portion 130 may include one or more handles for securing and releasing the latching mechanism with the vehicle latch portion. In one embodiment a single handle is used. Such a handle may be reached from the exterior through a slit in cover piece 140, for example. In another embodiment a handle of latch portion 130 extends through cover piece 140 for easy use from outside the vehicle. A lock may be included with latch 130 to prevent unauthorized opening CVD 100.

CVD 100 further includes a cover piece 140 that covers frame 110. In some embodiments cover piece 140 is a weatherproof, flexible material (e.g., canvas) that is secured to frame 110. The cover piece 140 may be secured to the frame 110 by a fastener such as zippers, buttons, magnets, clips, or in any suitable way. In an alternative embodiment, the cover piece 140 may include a transparent window area. In further embodiments, cover piece 140 itself is transparent or semi-transparent. Cover pieces with different features (e.g., material weight, transparency, designs) may be easily attached and removed from the frame such that a user may interchange a collection of cover pieces so that the cover piece display is most suitable at a particular time. For example, the cover piece 140 may be secured such that the cover piece is a material that can be easily removed from the frame 110 by an occupant to facilitate rapidly exiting the vehicle in an emergency.

In some embodiments cover piece 140 includes a plurality of sealant strips to reduce the possibility of exterior conditions affecting the vehicle cabin conditions. The sealant strips may be positioned at locations where CVD 100 matches the contour of the vehicle door frame. Accordingly, when the CVD 100 is closed and the latch portion 130 is secured, interior conditions are insulated from the exterior conditions of vehicle.

The sealant strips may be made of rubber or other suitable material to provide an airtight or watertight seal. Where an airtight seal is not practical or desired sealant strips may be used to reduce airflow in and out of the vehicle cabin. Where a watertight seal is not practical or desired sealant strips may be used to reduce waterflow in and out of the vehicle cabin.

In some embodiments a latch portion of the CVD is engaged with a latch portion of the vehicle as part of installing the CVD on the vehicle. The combination of connecting the hinge portions and engaging the latch portions may secure the cabin of the vehicle against exterior conditions such as inclement weather, perceived wind caused by driving the vehicle at street speeds and serve to discourage theft from the vehicle cabin.

CVD utilization is simple and requires no tools or instruction for the end user. The CVD of the invention latches to the top and bottom of the door frame and then rolls down like a shade when needed for use. According to the preferred embodiment, two or more straps hold the frame in place at the top and bottom of the vehicle door frame. Because of this fully customizable design, the same CVD may be used for front or rear door replacement.

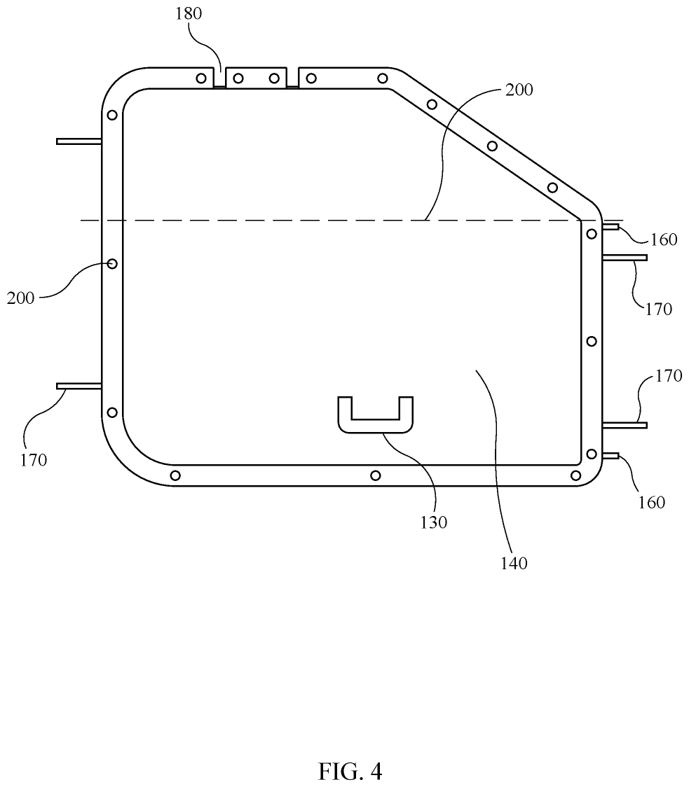

In a preferred embodiment, the CVD of the invention may be secured to the sides and bottom of the door frame by using one or more magnets that are sewn into place inside the material of the CVD comprising three evenly spaced magnets along the top and bottom portion of the CVD and four evenly spaced magnets along each side as shown in FIG. 4. According to the invention shown in FIG. 4, magnets 200 are placed on either side of a slit 180 within the cover piece of the flexible frame. Slit 180 is secured into the cover piece by means of a seam 220. Slit 180 allows the fixed hinge component of the frame to slide through the CVD 100. This unique design allows the CVD 100 to lay flat against the frame of the vehicle and prevents the CVD 100 from bunching up over the frame, which would allow for gaps and possible breach of the CVD 100 seal.

According to the method of the invention, an end user releases the straps which hold the cover in place, then stretches the cover over the vehicle cabin and then creates a solid, smooth fit by sliding the magnets farther apart until a desired fit is achieved. Additionally, the CVD may be further secured by the end user adjusting one or more hook/loop straps along the door frame post. By securing the magnets on the interior of the CVD fabric, a barrier is created between the magnet and frame which prevents the magnets from damaging the vehicle.

The CVD of the invention has a sewn in seam from the top front corner of the CVD, straight down to the bottom of the CVD. This seam allows the front of the CVD to fold over to the remaining body of the CVD to form a rectangular shape. This shape then allows for quick roll up and storage of the CVD. Likewise, when the CVD is unrolled for use, the front flap is quickly and easily folded open to attach the front of the CVD to the vehicle frame.

Advantageously, the use of magnets as a means for attaching the CVD to the vehicle frame speeds up the initial deployment of the CVD and creates an improved barrier to the outside elements around a vehicle cabin. Zipper or hook/loop methods of securing a CVD require a permanent frame attachment to the frame of the vehicle (e.g. the loop side of hook/loop or one side of the zipper mechanism) which results in a slower and less secure deployment. According to the disclosed invention, full deployment of the CVD using this method can be achieved in under thirty (30) seconds without needing additional tools or instruction.

Preferably, the magnets used in the alternative embodiment shown in FIG. 4 are neodymium iron boron, sometimes referred to as “N45” magnets, or any magnet capable of producing a coercive magnetic field strength of at least (1,000 oersted). Alternative magnets which can be used include samarium cobalt and aluminum-nickel-cobalt alloy.

The magnets used in the invention are preferably circular and are sized from about 0.5 to about one inch in diameter and from about 0.125 to about 0.5 inches in thickness. The ratio of diameter to thickness is preferably in the range of 8:1 to 1:1. Magnets having ratios in this range are sufficiently small to slip into the fold of the CVD while providing sufficient surface area to firmly attach to through the CVD lining to the frame of the vehicle. Further, larger magnet diameters and thicknesses are too large to allow the CVD to roll up without bunching or binding.

Preferably, the CVD is constructed of any suitable material that is flexible enough to be rolled into a closed position such as a vinyl/polyurethane composition. The CVD of the invention may also be removed from the vehicle and used as a ground cover. Because of this alternative use, the material of the CVD is preferably comprised of vinyl and clear polyurethane having a thickness of from about 30 gauge to about 40 gauge. This thickness range allows the material to maintain sufficient flexibility to be rolled into the stored position, but also provides the CVD with adequate strength to be resistant to penetration from various externalities including small, jagged rocks, rough sand, dry dirt, hail, snow, and heavy rain.

The assembly of the CVD of the invention allows for quick push out exit from the vehicle in case of an emergency. The outside portion of the door remains intact while the middle area of door pops out for exiting vehicle in emergency or to access the interior of the vehicle without completely removing the door. In normal operation, the lower straps can be unclipped and the entire door will open for easy exit from the vehicle.

Having thus described several aspects of at least one embodiment of this invention, it is to be appreciated that various alterations, modifications, and improvements will readily occur to those skilled in the art.

Such alterations, modifications, and improvements are intended to be part of this disclosure and are intended to be within the spirit and scope of the invention. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In some embodiments, the hinge portion has a securing portion the secures the hinge portion to the frame; and a pin portion connected to the securing portion and configured to attach to a vehicle hinge portion of the vehicle. The securing portion may have a through hole for securing the pin portion, the through hole having a first side and a second side, both sides being configured to interchangeably receive the pin portion. The pin portion may be connected to the securing portion through the first side of the through hole.

In some embodiments, the hinge portion comprises a pin configured to be received by a vehicle hinge portion of the vehicle.

The hinge portion may have a pin configured to be received by a cylindrical receiving portion of the vehicle proximal to the door frame of the vehicle.

In some embodiments the hinge portion of the collapsible vehicle door comprises a pin and connection to the vehicle door frame is achieved by inserting the pin into the hinge portion of the stock vehicle.

In some embodiments, the door hinge portion comprises a pin portion which is inserted into a cylindrical portion of the vehicle hinge portion.

In some embodiments, the at least two of the plurality of hinge pieces are fixed together using a pivot piece.

In some embodiments the door hinge portion has a securing portion the secures the door hinge portion to the frame; and a pin portion connected to the securing portion and configured to attach to the vehicle hinge portion of the vehicle, wherein the securing portion has a through hole for securing the pin portion, the through hole having a first side and a second side, both sides being configured to interchangeably receive the pin portion.

1. A collapsible vehicle door for use with a vehicle, the collapsible vehicle door comprising:
a flexible frame that can be rolled into a collapsed configuration, wherein the flexible frame comprises two sides, a top and a bottom;
a latch secured to the flexible frame piece;
a hinge portion secured to the flexible frame piece; and
a cover piece comprising three evenly spaced magnets along the top and bottom of the flexible frame and four evenly spaced magnets along each side of the flexible frame, wherein the magnets are characterized as being capable of producing a coercive magnetic field strength of at least 1,000 oersted.

2. The collapsible vehicle door of claim 1, wherein the frame has a single perimeter.

3. The collapsible vehicle door of claim 2, wherein the single perimeter of the frame matches a contour of a door frame of the vehicle.

4. The collapsible vehicle door of claim 1, wherein the hinge portion has:
a securing portion the secures the hinge portion to the frame; and
a pin portion connected to the securing portion and configured to attach to a vehicle hinge portion of a vehicle door frame.

5. The collapsible vehicle door of claim 4, wherein the securing portion has a through hole for securing the pin portion, the through hole having a first side and a second side, both sides being configured to interchangeably receive the pin portion.

6. The collapsible vehicle door of claim 5, wherein the pin portion is connected to the securing portion through the first side of the through hole.

7. The collapsible vehicle door of claim 1, wherein the cover piece is further secured to the flexible frame piece by a fastener selected from the group consisting of zippers, buttons, and clips.

8. The collapsible vehicle door of claim 1, wherein the cover piece includes a transparent window area.

9. The collapsible vehicle door of claim 1, wherein the cover piece includes a plurality of sealant strips.

10. The collapsible vehicle door of claim 1, wherein the flexible frame is comprised of a material selected from the group consisting of plastics and carbon fiber composites.

11. The collapsible vehicle door of claim 1, wherein the magnets are sewn into channels inside the cover piece.

12. The collapsible vehicle door of claim 11, wherein the collapsible vehicle door includes a sewn in seam extending from the top front corner of the collapsible vehicle door to the bottom of the collapsible vehicle door.

13. The collapsible vehicle door of claim 1, wherein the magnets are selected from the group consisting essentially of neodymium iron boron, samarium cobalt and aluminum-nickel-cobalt alloy magnets.

14. The collapsible vehicle door of claim 1, wherein the magnets are round and are sized from about 0.5 to about one inch in diameter and from about 0.125 to about 0.5 inches in thickness.

15. The collapsible vehicle door of claim 14, wherein the ratio of diameter to thickness of the magnets is in a range of from about 8:1 to 1:1.

16. A method for deploying a collapsible vehicle door, wherein the collapsible vehicle door comprises:
a flexible frame that can be rolled into a collapsed configuration, wherein the flexible frame comprises two sides, a top and a bottom;
a latch secured to the flexible frame piece;
a hinge portion secured to the flexible frame piece; and
a cover piece comprising three evenly spaced magnets along the top and bottom of the flexible frame and four evenly spaced magnets along each side of the flexible frame, wherein the magnets are characterized as being capable of producing a coercive magnetic field strength of at least 1,000 oersted,
wherein the deploying method comprises the steps of:
releasing the flexible frame from a collapsed configuration;
stretching the cover piece over the vehicle cabin; and
sliding the magnets farther apart until a desired fit is achieved.
